(19) United States
(12) Patent Application Publication
(10) Pub. No.: US 2025/0378728 A1
(43) Pub. Date: Dec. 11, 2025

(54) Portable See-Through Vending Machine Made of Wood with Individual Lockable Compartments and QR Code Payment System

(71) Applicant: ANDRE GUEZIEC, Sunnyvale, CA (US)

(72) Inventor: ANDRE GUEZIEC, Sunnyvale, CA (US)

(21) Appl. No.: 18/736,155

(22) Filed: Jun. 6, 2024

(51) Int. Cl. G07F 9/00; E05B 73/00; G06Q 20/18; G07F 11/00; G07F 11/40

(52) U.S. Cl. CPC G07F 9/001; E05B 73/0005; G06Q 20/18; G07F 11/005; G07F 11/40

(57) ABSTRACT

The invention provides a see-through, portable vending machine made of wood, featuring individual lockable compartments and a QR code-based payment system. Each compartment has a unique lock code, delivered to the client upon successful payment, either automatically or manually by the machine owner. The power supply is optional, enhancing the machine's versatility for various settings. This design combines aesthetic appeal with modern payment convenience, making it suitable for refined and temporary retail settings.

### RELATED FIELD

The present invention relates to vending machines, particularly to a portable, see through vending machine constructed of wood, featuring individual lockable compartments and a QR code-based payment system.

### BACKGROUND

Traditional vending machines are typically constructed from metal or plastic, are bulky, and integrate the storage, dispensing, and payment functions into a single unit. There is a need for a more aesthetically pleasing, portable vending machine that can fit in more refined settings, such as upscale events, boutique markets, and artisanal fairs. Moreover, integrating modern payment methods like QR codes can enhance the user experience by providing secure and convenient transaction options.

### SUMMARY

The present invention provides a see-through, portable vending machine made of wood, designed with individual compartments for storing products. Each compartment has a unique lock code. The machine uses a QR code-based payment system, where instructions for payment are provided on a label next to each compartment. Upon successful payment, the proper lock code for the purchased item is delivered to the client automatically or manually by the machine owner. The power supply for this vending machine is optional, enhancing its versatility for various settings. The box itself is preferably located on some furniture in an indoor setting and may be attached to a counter or similar furniture and secured via a cable lock, or be bolted. In this way the box is movable from the standpoint of the owner, who can easily bolt it or locate it elsewhere, but not from the standpoint of the customer, for whom it is unpractical and cumbersome to move it. This invention is particularly suited for an impulse purchase, wherein a customer is tempted by the items in the see-through vending machine and can instantly satisfy their impulse by obtaining an unlock code after paying for the item or otherwise obtaining the access code according to the rules that the owner of the box set.

### Prior Art

Vending machines have existed since the 19^{th} Century. Typical vending machines are bulky, heavy, expensive, and in need of significant power to operate. The dispensing mechanisms, and especially payment systems, and more recently, electronics, have added to the complexity, weight, power needs and possible noise generation of the machines. Such machines are unsuitable for a refined setting, contrary to the present invention.

Certain hotel rooms have also long been equipped with means, usually called “minibars”, to upsell items such as drinks or snacks, optionally using see-through windows, in individual rental rooms, suites or units. These generally work when there is direct face-to-face interaction with the guest during their stay and especially at check-out, asking them about the taking or perusal of items, and having housekeeping promptly inventory and replenish. Minibars are becoming less popular for several reasons: Taking inventory of minibars, maintaining and restocking promptly after each guest departs is labor-intensive and costly. Discrepancies and disputes over minibar charges can create friction, leading to customer dissatisfaction. Our invention as described below solves this problem.

Recently the company Amazon.com has developed a non-see-through lockbox system titled “Amazon Locker”. It is used to retrieve pre-purchased items, following a set of instructions made available to the customer ahead of time, and is not see-through, and is not suitable for impulse purchasing contrary to the present invention.

In the US Patent Application titled “Systems and methods for secure package delivery and retrieval” U.S. Ser. No. 16/934,408 and filed Jul. 21, 2020 by Jerry Anderson, Jay Houser and Guy a system is described for secure package retrieval. This system has similarities with the abovementioned “Amazon Locker” and allows secure retrieval of items. It is not see-through and does not lead itself to impulse purchasing as the present invention does.

In the US Patent titled “DEVICE FOR STORING OBJECTS AND METHOD FOR USING SUCH A DEVICE” number 11,989,996 B2 dated May 21, 2024 by Excoffier, a sophisticated, electronic, and sensor-based locker system is presented, also with some similarities to “Amazon Locker” but not permitting an instant purchase nor presenting products in a refined setting as our present invention permits. In addition, our invention does not require the vending machine itself to be powered as the Excoffier method does.

QR Codes have been used in commerce before, as described in Grinberg's “Method and Apparatus for Facilitating Payment via Mobile Networks” filed Aug. 23, 2013 Pub No 2013/0346299 A1. However, Grinberg does not disassociate the vending machine from the payment system and cash register as we do in the present invention. As discussed above, the main reason vending machines are impractical in refined settings is that they combine numerous functions including that of a cash register, creating weight, bulk, need for power and additional inconveniences. Our present invention addresses these shortcomings.

### BRIEF DESCRIPTION OF THE DRAWINGS

FIG. 1 illustrates a front view of the see-through portable vending machine

FIG. 2 illustrates a front view of the see-through portable vending machine and depicts the QR code label and payment instruction setup.

FIG. 3 shows a side view of the vending machine, highlighting the wooden construction and individual compartments.

FIG. 4 provides a block diagram of the overall system, including the QR code payment system and lock code delivery mechanism.

FIG. 5 illustrates the portable vending machine, wherein the QR codes are on the machine housing.

### DETAILED DESCRIPTION

Providing the option to purchase or otherwise acquire an item that is in view and displayed, or otherwise in a lock box, but not readily accessible, while the seller is not physically present, is a significant business need.

The recent popularity of home rentals without face to face interactions using services such as VRBO and Airbnb has generated a need for a new portable vending machine system, notably one such system able to perform in a refined setting, as none of the existing systems as above mentioned were suitable in these settings. Indeed, the author of the present specification has visited numerous such rentals in recent months and no system such as the one in the present invention was observed: None of the “Airbnb's” or “VRBO's” as they are referred to, had any form of a paid/up-sell “minibar” other than offering goodies/drinks/snacks for free as a gift. This offers another clue that the following is truly novel.

This brings us to the object of the present vending machine invention:

### 1. Vending Machine Structure

The vending machine (100) comprises a see-through wooden housing (101) made from high-quality timber, offering an aesthetic appeal suitable for refined settings. The housing includes multiple individual compartments (102), each equipped with a unique lock (103). Each compartment has a window (104) made of glass or polycarbonate. The machine is designed to be portable, being lightweight and of small dimensions, and easily carried. The housing preferably has a loop (105) or other means to attach a cable lock or other fixation device so it may not easily by moved by a customer.

### 2. Individual Compartments

Each compartment (102) is designed to store a single product or a small group of products. The compartments are lockable with unique codes, ensuring secure storage and preventing unauthorized access. The wooden construction provides a warm, traditional look while ensuring durability.

### 3. QR Code Payment System

Each compartment (102) has an adjacent label (106) displaying a QR code (107) and instructions on how to pay for the item within the compartment. The QR code links to a secure payment gateway where the client can complete the transaction using various payment methods (e.g., credit card, mobile payment services). Optionally, a single label might be suitable for a multiplicity of compartments, as long as instructions within the label pertain to the multiple compartments.

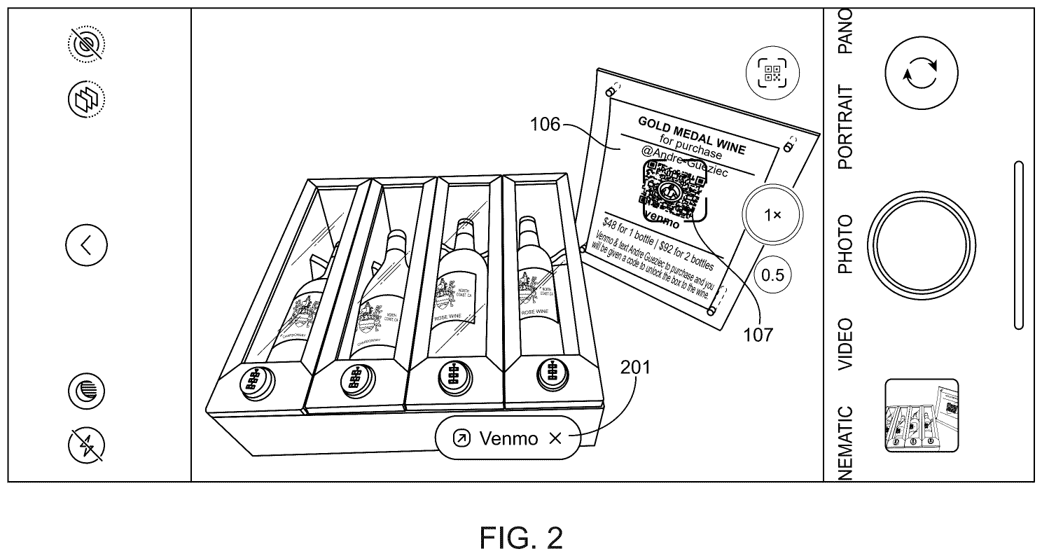

Referring to FIG. 2, upon selection of the QR code (107) Payment instructions (201) are being offered.

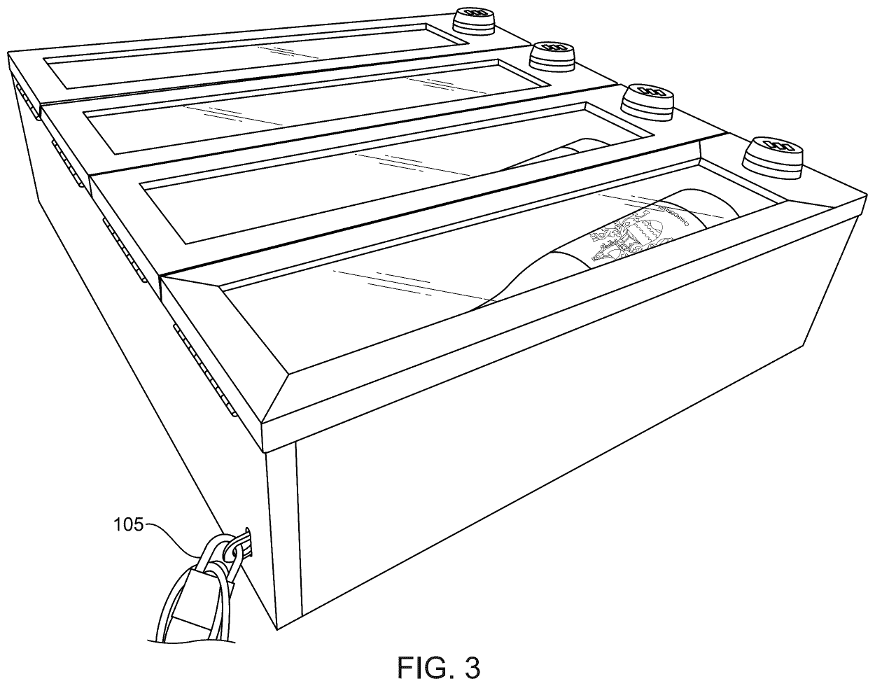

Referring to FIG. 3. The loop (107) is preferably located at a corner of the vending machine (100).

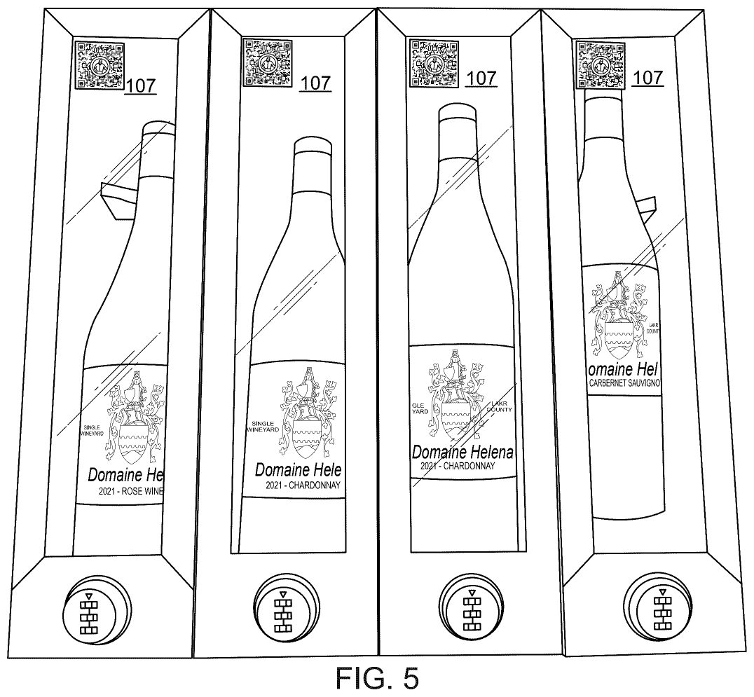

Referring to FIG. 5. The QR codes (107) can be located on the machine housing and do not need to be separated from the machine housing.

### 4. Payment and Lock Code Delivery

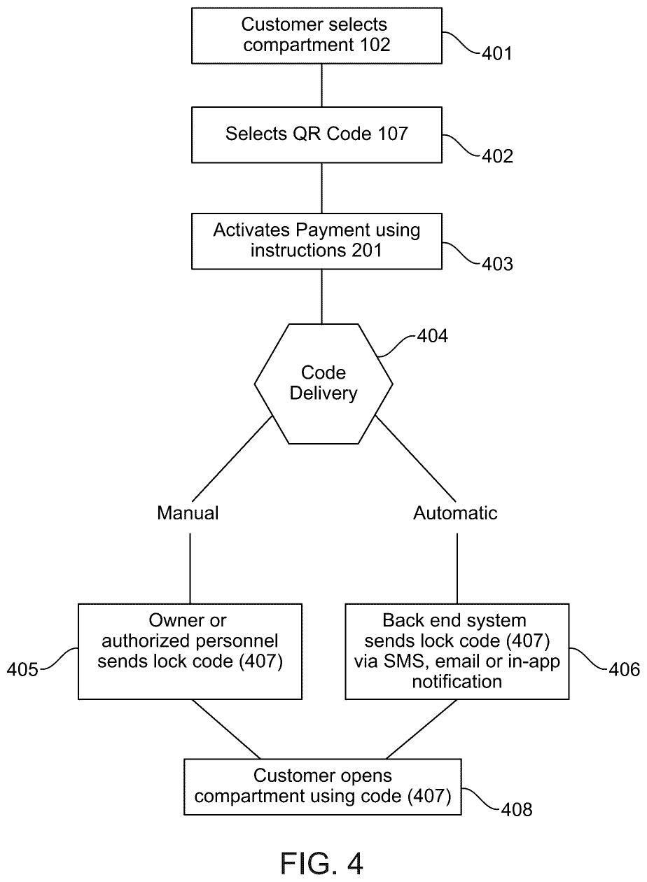

Referring to FIG. 4, in Step 401 a customer selects a compartment (102) and a QR Code 107 in Step 402. In Step 403 they activate payment using instructions 201.

In Step 404 Upon successful payment, the system delivers the lock code for the purchased compartment. This can be done in two ways:
**Manual Delivery:** In Step 405 The machine owner or an authorized personnel receives a notification of the payment and manually sends the lock code (407) to the client.
**Automatic Delivery:** In Step 406 The payment gateway integrates with a backend system that automatically sends the lock code (407) to the client via SMS, email, or an in-app notification.

In Step 408 the customer opens the compartment (102) using the lock code (407)

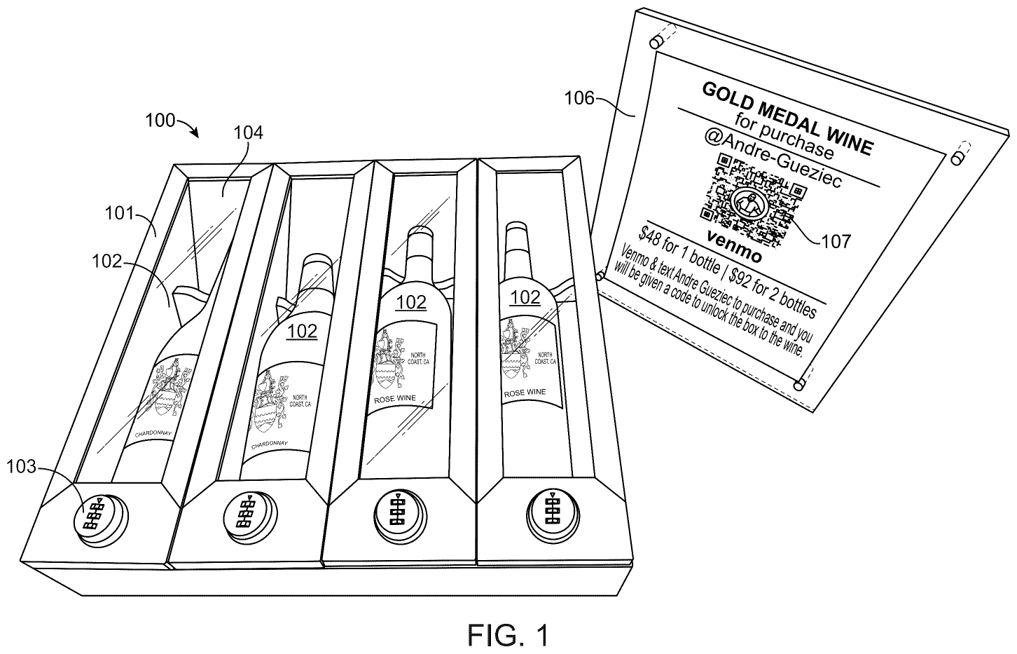

Lock codes (407) may be three-digit codes that are conveniently remembered by the owner but hard to remember for the customer. In the embodiment of the vending machine (100) as depicted in FIG. 1, there are preferably 4 distinct compartments (102). The owner may choose a 4 digit number as a date, possibly a date of birth or other memorable date.

By way of example, if the date 1998 is chosen, from left to right the lock codes for individual compartments would be 199, 998, 981, and 819 respectively, obtained by repeating the first 2 digits and appending them to the end of the date: 199819, resulting in a 6 digit number, and by making groups of three consecutive digits starting at positions 1, 2 3 and 4 of the 6 digit number. Simple arithmetic will allow to instantly re-compute each lock code from the single 4 digit date, which is easy to remember for the owner.

Since it is known which lock codes were supplied to customers and which compartments accessed, it is not necessary to physically send someone to inventory and the vending machine can be replenished at longer intervals. For instance, one can wait till all the key codes were given and compartments accessed. This is especially true in case all compartments contain substantially the same item.

### 5. Power Supply

The vending machine (100) can optionally be powered by a rechargeable battery (108) or connected to an external power source, ensuring flexibility in various settings. However, the essential functions of the machine, including the QR code payment system and lock code delivery, do not necessarily depend on this power supply.

### 6. User Interface and Instructions

The label (106) next to each compartment provides clear instructions for the payment process, including how to scan the QR code and the steps to receive the lock code. The instructions are designed to be user-friendly and may include multiple languages to cater to a diverse clientele.

### 7. Security Features

The vending machine includes robust security features to protect both the products and the transaction process. Each compartment lock (103) is tamper-resistant, and the overall wooden housing (101) is reinforced to withstand physical tampering. Additionally, the QR code payment system uses encrypted communication to ensure secure transactions.

### 8. Additional Features and Embodiments

The box is preferably an ornate, preferably wooden, box inside a rental room or house, but may also be located outdoors in a public setting, or in a public indoor setting, or in an office building.

In other embodiments, the vending machine box might possibly be very basic looking and might optionally not be see-through as long as it has a lock, and is generally not moveable by the client and resisting tampering.

The vending machine may optionally be made using material other than wood, such as composite, plastic, metal, polycarbonate, or any suitable material that is sufficiently sturdy.

The present invention may also be used to gift certain items to certain people, not involving payment. The locking mechanism still provides for the chosen item to be reserved to the chosen person or persons possessing the proper code to unlock the item.

In another embodiment the label could be electronic and delivered to the client via email, text message, electronic chat or other electronic means.

In another embodiment the wooden housing may have handles and wheels attached to facilitate transportation between locations.

In another embodiment the present invention can be used as a lock box for retrieval, without the requirement for payments. An object can be placed in a compartment and possibly hidden from view with a cover, and later retrieved with the appropriate unlocking code.

1. A see-through portable vending machine comprising:
a wooden housing with one or more individual lockable compartments, each having a see-through window;
a QR code-based payment system;
a mechanism for delivering the lock code to the client upon successful payment;
a label adjacent to the housing with payment instructions and QR code.

2. The portable vending machine of claim 1, wherein the wooden housing is made of high-quality timber.

3. The portable vending machine of claim 1, wherein each compartment has a unique lock code.

4. The portable vending machine of claim 1, wherein the lock code is delivered automatically via SMS, email, or an in-app notification upon successful payment.

5. The portable vending machine of claim 1, wherein the lock code is delivered manually by the machine owner, or an authorized personnel upon notification of successful payment.

6. The portable vending machine of claim 1, wherein the power supply is optional and includes a rechargeable battery and/or connection to an external power source.

7. The portable vending machine of claim 1, wherein the payment system uses encrypted communication for secure transactions.

8. The portable vending machine of claim 1, wherein portability features include handles and wheels.

9. The portable vending machine of claim 1, wherein the housing has a loop for a cable lock.

10. A see-through portable vending machine comprising:
a wooden housing with one or more individual lockable compartments, each having a see-through window;
a QR code-based payment system for each compartment;
a mechanism for delivering the lock code to the client upon successful payment;
labels adjacent to each compartment with payment instructions and QR codes.

11. The portable vending machine of claim 10, wherein the wooden housing is made of high-quality timber.

12. The portable vending machine of claim 10, wherein each compartment has a unique lock code.

13. The portable vending machine of claim 10, wherein the lock code is delivered automatically via SMS, email, or an in-app notification upon successful payment.

14. The portable vending machine of claim 10, wherein the lock code is delivered manually by the machine owner or an authorized personnel upon notification of successful payment.

15. The portable vending machine of claim 10, wherein the power supply is optional and includes a rechargeable battery and/or connection to an external power source.

16. The portable vending machine of claim 10, wherein the payment system uses encrypted communication for secure transactions.

17. The portable vending machine of claim 10, wherein portability features include handles and wheels.

18. The portable vending machine of claim 10, wherein the housing has a loop for a cable lock.

19. A see-through portable vending machine comprising:
a wooden housing with one or more individual lockable compartments, each having a see-through window;
a QR code-based payment system;
a mechanism for delivering the lock code to the client upon successful payment;
a mechanism for delivering a label to the client with payment instructions and QR codes.

20. The portable vending machine of claim 19, wherein the lock code and labels are delivered automatically via SMS, email, or an in-app notification.

21. The portable vending machine of claim 19, wherein the lock code and label are delivered manually by the machine owner, or by authorized personnel.

22. A portable vending machine comprising:
a wooden housing with one or more individual lockable compartments;
a QR code-based payment system;
a mechanism for delivering the lock code to the client upon successful payment;
a label adjacent to the housing with payment instructions and QR code.

23. The portable vending machine of claim 22, wherein the wooden housing is made of high-quality timber.

24. The portable vending machine of claim 22, wherein each compartment has a unique lock code.

25. The portable vending machine of claim 22, wherein the lock code is delivered automatically via SMS, email, or an in-app notification upon successful payment.

26. The portable vending machine of claim 22, wherein the lock code is delivered manually by the machine owner, or by authorized personnel upon notification of successful payment.

27. The portable vending machine of claim 22, wherein the power supply is optional and includes a rechargeable battery and/or connection to an external power source.

28. The portable vending machine of claim 22, wherein the payment system uses encrypted communication for secure transactions.

29. The portable vending machine of claim 22, wherein portability features include handles and wheels.

30. The portable vending machine of claim 22, wherein the housing has a loop for a cable lock.
